(19) United States
(12) Patent Application Publication
(10) Pub. No.: US 2008/0002923 A1
(43) Pub. Date: Jan. 3, 2008

(54) Fluid bearing workholder for precision centering

(75) Inventors: Dustin A. Cochran, Boulder Creek, CA (US); Mark G. Steele, Scotts Valley, CA (US)

Correspondence Address: Seagate Technology;c/o DARBY & DARBY P.C., P.O. Box 770, Church Street Station, New York, NY, 10008-0770, US

(73) Assignee: SEAGATE TECHNOLOGY LLC, Scotts Valley, CA (US)

(21) Appl. No.: 11/477,674

(22) Filed: Jun. 30, 2006

(51) Int. Cl. F16C 32/06

(52) U.S. Cl. 384/100

(57) ABSTRACT

A workholder comprising a body comprising a fluid bearing and a fluid, wherein the fluid bearing is adapted to releasably retain a workpiece by maintaining the fluid in a gap between the workholder and the workpiece, wherein the fluid bearing is adapted to produce a radial and/or an axial force on the workpiece, and wherein the workholder does not include a mechanical interface to releasably retain the workpiece is disclosed. Also, methods of using and manufacturing the workholder are disclosed herein.

### RELATED APPLICATIONS

None.

### FIELD OF INVENTION

The present invention relates generally to machine tools, and more particularly, to a workholder made from fluid bearings.

### BACKGROUND

Some conventional workholders, such as lathe chucks, use jaws to grip a surface of a workpiece. There is typically an error in the interface between the jaws and the gripped surface, resulting in reduced accuracy. In addition, it is difficult to remove the workpiece to perform other types of operations and then reinstall it in the original workholder at the exact same centerline. Besides mechanical interface issues, error motion can also be induced by inaccuracy of the chuck's spindle bearings themselves.

Various hydrostatic workholders are known, such as that disclosed in U.S. Pat. No. 5,516,243, which has one or more chambers containing a fluid which, when pressurized contracts a relatively thin metal sleeve to engage and firmly hold and locate a tool shank received within the sleeve. While this hydrostatic tool holder is effective and reliable in use, the solid steel sleeve is contracted within its elastic limits, and only a very small amount, under the pressure of the fluid in use. U.S. Pat. No. 6,015,154 features a hydrostatic workpiece holder that has a metal sleeve that may be significantly displaced under a relatively low pressure of fluid applied to the sleeve to firmly hold a workpiece received adjacent to the sleeve.

Fluid bearings, which include fluid dynamic bearings and fluid hydrostatic bearings, are bearings which support load on a thin layer of liquid or gas. They are frequently used in high load, high speed or high precision applications where ordinary ball bearings have short life or high noise and vibration. They are also used increasingly to reduce cost. For example, hard disk drive motor fluid bearings are both quieter and cheaper than the ball bearings they replace.

Fluid bearings use a thin layer of liquid or gas fluid between the bearing faces, typically sealed around or under the rotating shaft. There are two principal ways of getting the fluid in to the bearing. In gas bearings and hydrostatic bearings, the fluid is pumped in through an orifice or through a porous material. In hydrodynamic bearings, bearing rotation sweeps the fluid in to the bearing, forming a lubricating wedge under or around the shaft.

A hydrostatic bearing requires an external pressurized fluid source to maintain the fluid separation. Relative motion between the bearing surfaces in a hydrodynamic bearing causes a sheer element that occurs entirely within the fluid film such that no contact between the bearing surfaces occurs. Hydrostatic bearings have been commonly used to provide uniform load distribution.

Hydrostatic bearings for bearing a supported surface relative to a supporting surface, with a space between the two bearing surfaces, are known. Typically, such bearings are of one or the other of two general types. A first of these general types is designed for use in a recirculating fluid system. The other general type of known hydrostatic bearing employs one or more seals that contact both the supported surface and the supporting surface of the bearing in order to contain the hydraulic fluid.

A typical recirculating fluid system, as associated with a hydrostatic bearing, includes a pump for causing hydraulic fluid to flow through a space between two surfaces, i.e., a supporting surface and a supported surface. The pump provides sufficient pressure to the fluid for flotation of the supported surface relative to the supporting surface, such that neither surface contacts the other. The hydraulic fluid escapes past the periphery of the space between the two, non-contacting surfaces, and is collected and returned to the pump for recirculation. Recirculating fluid systems are generally considered quite adequate for relatively low pressure hydraulic bearing systems, e.g., of the order of 3,000 p.s.i. or less, but are not suitable for operation at very high pressures due to the excessive power requirement which would be involved in simultaneously recirculating a hydraulic fluid and maintaining it at a very high pressure level.

In the case of a hydrostatic bearing which employs one or more seals for contacting both a supported surface and a supporting surface of the bearing, such seals are utilized in order to avoid leakage of the hydraulic fluid past the periphery of the space between the two surfaces, while a pressure is maintained in the fluid by a pump in order that the supported surface may float relative to the supporting surface. A higher pressure capability is generally sought through the use of such an arrangement, the higher pressure capability, of course, permitting the bearing to handle a relatively large load using a relatively small surface area.

In a hydrodynamic bearing, a lubricating fluid or gas provides a bearing surface between, for example, a stationary member of a housing and a rotating member of a hub. The applied load is carried by pressure generated within the fluid, and frictional resistance to motion arises entirely from the shearing of the viscous fluid. Typical lubricants include oil or ferromagnetic fluids. Hydrodynamic bearings spread the bearing surface over a larger surface area in comparison with a ball bearing assembly, which comprises a series of point interfaces. This is desirable because the increased bearing surface decreases wobble or run-out between the rotating and fixed members. Hydrodynamic bearings rely on bearing motion to sweep fluid in to the bearing. The fluid is pressurized internally by viscous shear. Hydrodynamic bearings may have high friction and short life at low speed or during starts and stops. Thus, a secondary bearing may be used for startup and shutdown to prevent damage to the hydrodynamic bearing. A secondary bearing may have high friction and short operating life, but good overall service life if bearing starts and stops are infrequent.

Many current fluid dynamic bearing designs are a combination of journal and thrust bearings. Frequently, these designs include a shaft journal bearing design having a thrust plate at an end thereof, or a dual conical bearing design, including a conical bearing at or close to either end of the shaft. The conical bearings typically include a grooved surface on each cone; the thrust plate bearings typically include two grooved surfaces, one facing each of the gaps defined by the thrust plate and sleeve, and by the thrust plate and counterplate.

Most known hydrodynamic bearing designs are based on a fixed shaft and rotating surrounding sleeve. However, by switching to a rotating shaft, significant improvements in power consumption and vibration response could be achieved with no trade-offs in performance. The power consumption would be decreased by using a smaller diameter shaft that is allowed when the vibration performance becomes less dependent on the shaft stiffness as occurs when the sleeve is stationary and cantilevered or supported from the base.

Fluid bearings can be relatively cheap compared to other bearings with a similar load rating. The bearing can be as simple as two smooth surfaces with seals to keep in the working fluid. In contrast, a conventional bearing may require many high-precision rollers with complicated shapes. Hydrostatic and gas bearings do have the complication and expense of external pumps. Most fluid bearings require little or no maintenance, and have almost unlimited life. Conventional mechanical ball bearings usually have shorter life and require regular maintenance. Pumped hydrostatic and aerostatic (gas) bearing designs retain low friction down to zero speed and need not suffer start/stop wear, provided the pump does not fail. Fluid bearings generally have very low friction—far better than mechanical bearings. One source of friction in a fluid bearing is the viscosity of the fluid.

Viscosity is a measure of the resistance of a fluid to deform under shear stress. It is commonly perceived as “thickness”, or resistance to pouring. Viscosity describes a fluid's internal resistance to flow and may be thought of as a measure of fluid friction. Thus, water is “thin”, having a lower viscosity, while vegetable oil is “thick” having a higher viscosity. All real fluids (except superfluids) have some resistance to shear stress, but an idealized fluid which has no resistance to shear stress is known as an ideal fluid. In general, in any flow, layers move at different velocities and the fluid's “thickness” arises from the shear stress between the layers that ultimately opposes any applied force. Newton postulated that, for straight, parallel and uniform flow, the shear stress, τ, between layers is proportional to the velocity gradient, ∂u/∂y, in the direction perpendicular to the layers, in other words, the relative motion of the layers.

$$τ = μ \frac{\partial u}{\partial y}$$

In the above equation, the constant μ is known as the coefficient of viscosity, viscosity, or dynamic viscosity. Many fluids, such as water and most gases, satisfy Newton's criterion and are known as Newtonian fluids. Non-Newtonian fluids exhibit a more complicated relationship between shear stress and velocity gradient than simple linearity.

The relationship between the shear stress and the velocity gradient can also be obtained by considering two plates closely spaced apart at a distance t. Assuming that the plates are very large, with a large area A, such that edge effects are neglected and that the lower plate is fixed, let a force F be applied to the upper plate. Incidentally, if this force causes the plate to move, the substance is concluded to be a fluid. The velocity of the moving plate and the top, the applied force is proportional to the area and velocity of the plate and inversely proportional to the distance between the plates. Combining these three relations results in the equation F=μ(AU/t). Where mu is the proportionality factor called the absolute viscosity (with units Pa-s or slugs/s-ft). The equation can be expressed in terms of shear stress; ρ=F/A=μ(U/t). U/t is the rate of angular deformation and can be written as an angular velocity, du/dy. Hence, through this method, the relation between the shear stress and the velocity gradient can be obtained.

Hydrostatic gas bearings are among the lowest friction bearings. However, lower fluid viscosity also typically means fluid leaks faster from the bearing surfaces, thus requiring increased power for pumps or seals.

Since no rigid mechanical element supports load, it may seem fluid bearings can give only low precision. In practice, fluid bearings have clearances that change less under load (are “stiffer”) than mechanical bearings. It might seem that bearing stiffness, as with maximum design load, would be a simple function of average fluid pressure and the bearing surface area. In practice, when bearing surfaces are pressed together, the fluid outflow is greatly constricted. This significantly increases the pressure of the fluid between the bearing faces. As fluid bearings faces are comparatively large areas, even small fluid pressure differences cause large restoring forces, maintaining the gap.

Fluid bearings are typically quieter and smoother (more consistent friction) than mechanical bearings. It is very difficult to make a mechanical bearing which is atomically smooth and round; and mechanical bearings deform in high-speed operation due to centripetal force. In contrast, fluid-bearings self-correct for minor imperfections. For example, hard disks manufactured with fluid bearings have noise ratings for bearings/motors on the order of 20-24 dB, which is a little more than the background noise of a quiet room. Drives based on rolling-element bearings are typically at least 4 dB noisier.

Viscosity and anti-wear performance are considerations in fluid bearings. The lubrication properties that may be controlled and the degree of control that may be obtained are unique to these bearings. In addition to viscosity and anti-wear, other important properties include power dissipation, migration, vapor pressure and evaporation rate, resistance to oxidation and corrosion, rheology, boundary properties and system compatibility. Viscosity determines power dissipation and bearing stiffness, which should be relatively constant over various operating conditions. The lubricant may have low migration so the lubricant does not creep out of the bearing. The lubricant may have a high resistance to oxidation and reactivity to provide a long life for the bearing. Rheology is the deformation and flow response to shear. The lubricant may also be compatible with the other materials.

### SUMMARY OF THE INVENTION

An embodiment of the invention relates to a workholder comprising a body comprising a fluid bearing and a fluid, wherein the fluid bearing is adapted to releasably retain a workpiece by maintaining the fluid in a gap between the workholder and the workpiece, wherein the fluid bearing is adapted to produce a radial and/or an axial force on the workpiece, and wherein the workholder does not include a mechanical interface to releasably retain the workpiece.

Preferably, the workholder further comprises a source of the fluid. Preferably, the fluid bearing is a hydrostatic bearing or a hydrodynamic bearing. Preferably, the fluid is a liquid or gas delivered to the gap by an external source. Preferably, the fluid is pressurized internally by viscous shear. Preferably, the mechanical interface is a jaw, collet, chuck, magnetic chuck or clamping system. Preferably, the workpiece is constrained to only allow rotation along an axis of the workpiece. Preferably, rotational error motion of the workpiece is less than 1 μm.

Another embodiment of the invention relates to a method of holding a workpiece with a workholder comprising a body comprising a fluid bearing and a fluid, wherein the method comprises placing the workpiece in the fluid bearing, maintaining the fluid in a gap between the workholder and the workpiece, and releasably retaining the workpiece in the workholder, wherein the fluid bearing is adapted to produce a radial and/or an axial force on the workpiece, and wherein the workholder does not include a mechanical interface to releasably retain the workpiece.

The method could further comprise providing a source of the fluid. Preferably, the fluid bearing is a hydrostatic bearing or a hydrodynamic bearing. Preferably, the fluid is a liquid or gas delivered to the gap by an external source. Preferably, the fluid is pressurized internally by viscous shear. Preferably, the mechanical interface is a jaw, collet, chuck, magnetic chuck or clamping system. Preferably, the workpiece is constrained to only allow rotation along an axis of the workpiece. Preferably, rotational error motion of the workpiece is less than 1 μm.

Yet another embodiment of the invention relates to a method of manufacturing a workholder comprising assembling a fluid bearing adapted to releasably retain a workpiece by maintaining the fluid in a gap between the workholder and the workpiece, wherein the fluid bearing is adapted to produce a radial and/or an axial force on the workpiece, and wherein the workholder does not include a mechanical interface to releasably retain the workpiece and an external driver/rotor assembly.

Preferably, the method of manufacturing further comprising providing a source of the fluid. Preferably, the fluid bearing is a hydrostatic bearing or a hydrodynamic bearing. Preferably, mechanical interface is a jaw, collet, chuck, magnetic chuck or clamping system.

As will be realized, this invention is capable of other and different embodiments, and its details are capable of modifications in various obvious respects, all without departing from this invention. Accordingly, the drawings and description are to be regarded as illustrative in nature and not as restrictive.

### BRIEF DESCRIPTION OF THE DRAWINGS

FIG. 1 shows a perspective view of one embodiment of the present invention.

FIG. 2 shows dynamic testing results from one embodiment of the present invention.

### DETAILED DESCRIPTION

The embodiments of the invention address the problems associated with positioning a workpiece relative to one or more of its surfaces, which can be difficult when trying to achieve high accuracy. These problems were solved by developing a workholder comprising a body comprising a fluid bearing and a fluid, wherein the fluid bearing is adapted to releasably retain a workpiece by maintaining the fluid in a gap between the workholder and the workpiece, wherein the fluid bearing is adapted to produce a radial and/or an axial force on the workpiece, and wherein the workholder does not include a mechanical interface to releasably retain the workpiece.

The workholder of the embodiments of this invention may use hydrostatic or hydrodynamic bearings. One embodiment may further include a source of fluid. The fluid may be a liquid or gas delivered to the gap between the workholder and the workpiece by an external source. In another embodiment, the fluid may be pressurized internally by viscous shear.

In order to eliminate one of the problems associated with conventional workholders, jaws for gripping a surface of a workpiece have been eliminated. Instead of using a mechanical type interface, for example, a jaw, collet, chuck, magnetic chuck or clamping system, a fluid is maintained in a gap between the inner surface of the workholder such that the workpiece itself becomes one element of a fluid bearing. The workpiece may be in almost any form, such as cylindrical, conical, spherical, flat or irregular.

In one embodiment, the workpiece may be constrained to only allow rotation along an axis of the workpiece. In another embodiment, the rotational error motion of the workpiece is preferably less than 1 μm, and more preferably less than 0.1 μm.

In one embodiment, the fluid bearing can use virtually any fluid, including air, oil, water, alcohol or aqueous solutions of NaCl, NaNo₃, HF, HCl, HNO₃, NaOH or the like. Lubricant fluids may include an electrically non-conductive lubricant and an electrically conductive, non-metallic, non-magnetic additive that improves electrical conductivity of the lubricant without sacrificing desirable lubricating properties such as viscosity, anti-oxidation, anti-corrosion and anti-wear performance. Base lubricants may include a mineral-based hydrocarbon, a synthetic hydrocarbon, an ester or a combination of base lubricants. Mineral-based hydrocarbons are preferably highly refined (highly purified). Preferred additives may include organic polymers, such as a commercially available solution of a quartemized polymeric aminoamide ester, a nitrilo polymer, chlorobenzene and ethylene dichloride in aromatic and aliphatic hydrocarbons. The aromatic and aliphatic hydrocarbons have a 40-70% concentration as compared to the remaining elements of the additive solution. One example of such a commercially available solution is Tolad 511 from Petrolite Corporation, U.S.A. Another example of a suitable commercially available organic polymer includes a solution of a solvent (tolune, isopropyl alcohol, and other aromatic solvents C9-C16), dodecyl, benzene and sulfonic acid. Other commercially available solutions can also be used. Since the additives are non-metallic and non-magnetic, the additives do not adversely affect wear and viscosity performance. Other non-metallic additive solutions can also be used.

The concentration of the additive in the lubricant can be varied to achieve a desired conductivity. However, the concentration is preferably kept low such that the overall viscosity of the lubricant is not changed. Formulation of fluids for appropriate fluid bearing properties therefore may require different considerations than for fluids intended as general-purpose lubricants.

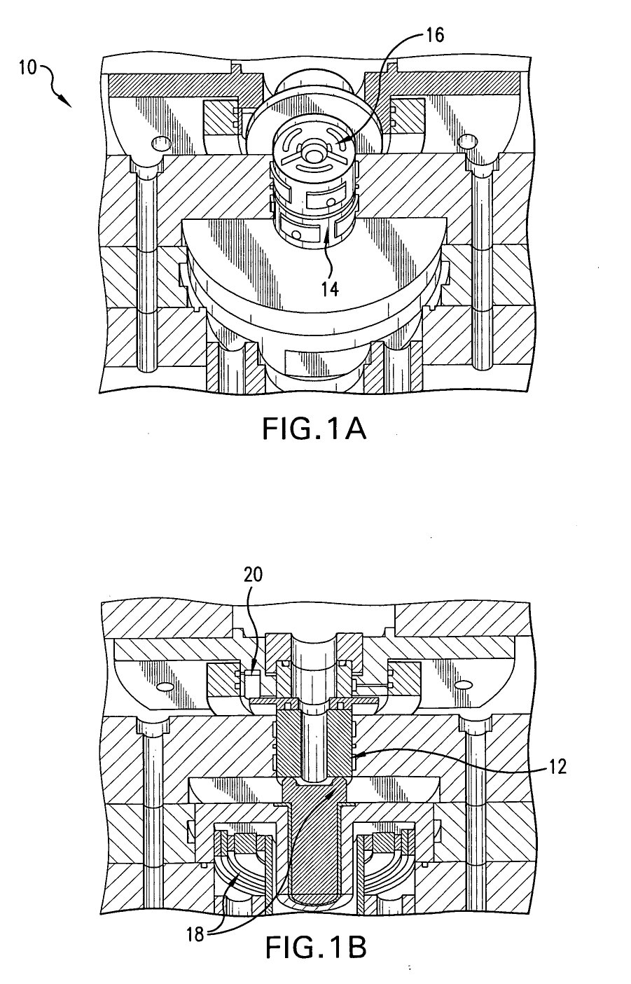

Referring to FIG. 1, in one embodiment, the workholder 10 may use the outside diameter and the flat surface on top of a fluid bearing as locating/hydrostatic bearing surfaces. The workpiece 12 may be captured by a radial 14 and/or thrust-type 16 hydrostatic bearing. Any number of machining operations may be performed on the workpiece 12 if the bearing has adequate stiffness, which may be determined by a number of factors, such as the surface area and pressure of the fluid.

The workpiece 12 may have a spin imparted to it by an external driver 18, which may be designed so that it minimizes any influence on the spin axis, which preferably is determined by the workpiece 12 surfaces. The bearings in the external driver assembly 18 may be designed so that they have minimal tilt resistance. The external driver/rotor assembly 18 may include its own magnet and stator and its own hydrostatic bearing set that is separate from the workpiece 12 holder bearing. The workpiece 12 may also remain static, with no imparted spin, if only precise centering is the desired effect.

In another embodiment, the workpiece 12 may be rotated by non-mechanical means such as an eddy current clutch magnetic coupling or by using the fluid escaping across the bearing pads to induce rotational motion by shearing the fluid.

In one embodiment, hydraulic pistons 20 may be used to create an axial loading to force the thrust hydrostatic bearing 16 onto the workpiece 12, which in turn forces the workpiece 12 onto the external driver 18 so that the part can be spun.

The gap between the workpiece 12 and the inner bearing surface may be matched based on the viscosity of the fluid used in the bearing. In one embodiment, the gap between the workpiece 12 and the inner bearing surface is preferably 12-15 μm.

Again referring to FIG. 1, the manufacturing of the workholder 10 would include assembling a fluid bearing 14 adapted to produce a radial force on a workpiece 12 and/or a fluid bearing 16 adapted to produce an axial force on a workpiece 12 and an external driver/rotor assembly 18. In another embodiment, an array of hydraulic pistons 20 may be included to create an axial loading to force the thrust hydrostatic bearing 16 onto the workpiece 12, which in turn forces the workpiece 12 onto the external driver 18 so that the part can be spun.

In one embodiment, the components of the workholder 10 bearing assembly may be fabricated from series 430 stainless steel. Other suitable materials include titanium, metals with high resistance to anodic corrosion, plastics with low absorbtivity of water and ceramics. The components may be made by casting, molding or powder metallurgy.

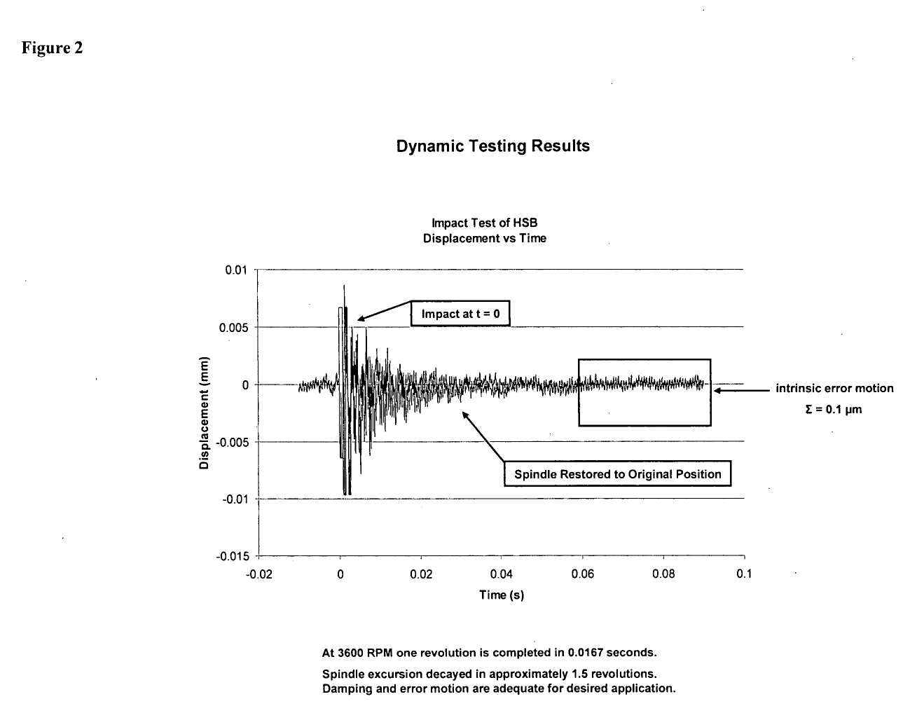

FIG. 2 illustrates an example of dynamic testing results of one embodiment of the workholder using a hydrostatic bearing. Rotodynamic testing using capacitance probes and signal processing was used to measure error motion. As a representative test sample, the rotational error motion of the spinning workpiece may be approximately 0.1 μm, regardless of how many times the workpiece was removed and replaced. These results show that the damping and error motion are adequate for most applications.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

This application discloses several numerical range limitations that support any range within the disclosed numerical ranges even though a precise range limitation is not stated verbatim in the specification because this invention can be practiced throughout the disclosed numerical ranges. Finally, the entire disclosure of the patents and publications referred in this application are hereby incorporated herein in entirety by reference.

1. A workholder comprising a body comprising a fluid bearing and a fluid, wherein the fluid bearing is adapted to releasably retain a workpiece by maintaining the fluid in a gap between the workholder and the workpiece, wherein the fluid bearing is adapted to produce a radial and/or an axial force on the workpiece, and wherein the workholder does not include a mechanical interface to releasably retain the workpiece.

2. The workholder of claim 1, further comprising a source of the fluid.

3. The workholder of claim 1, wherein the fluid bearing is a hydrostatic bearing or a hydrodynamic bearing.

4. The workholder of claim 1, wherein the fluid is a liquid or gas delivered to the gap by an external source.

5. The workholder of claim 1, wherein the fluid is pressurized internally by viscous shear.

6. The workholder of claim 1, wherein the mechanical interface is a jaw, collet, chuck, magnetic chuck or clamping system.

7. The workholder of claim 1, wherein the workpiece is constrained to only allow rotation along an axis of the workpiece.

8. The workholder of claim 1, wherein rotational error motion of the workpiece is less than 1 μm.

9. A method of holding a workpiece with a workholder comprising a body comprising a fluid bearing and a fluid, wherein the method comprises placing the workpiece in the fluid bearing, maintaining the fluid in a gap between the workholder and the workpiece, and releasably retaining the workpiece in the workholder, wherein the fluid bearing is adapted to produce a radial and/or an axial force on the workpiece, and wherein the workholder does not include a mechanical interface to releasably retain the workpiece.

10. The method of claim 9, further comprising providing a source of the fluid.

11. The method of claim 9, wherein the fluid bearing is a hydrostatic bearing or a hydrodynamic bearing.

12. The method of claim 9, wherein the fluid is a liquid or gas delivered to the gap by an external source.

13. The method of claim 9, wherein the fluid is pressurized internally by viscous shear.

14. The method of claim 9, wherein the mechanical interface is ajaw, collet, chuck, magnetic chuck or clamping system.

15. The method of claim 9, wherein the workpiece is constrained to only allow rotation along an axis of the workpiece.

16. The method of claim 9, wherein rotational error motion of the workpiece is less than 1 μm.

17. A method of manufacturing a workholder comprising assembling a fluid bearing adapted to releasably retain a workpiece by maintaining the fluid in a gap between the workholder and the workpiece, wherein the fluid bearing is adapted to produce a radial and/or an axial force on the workpiece, and wherein the workholder does not include a mechanical interface to releasably retain the workpiece and an external driver/rotor assembly.

18. The method of claim 17, further comprising providing a source of the fluid.

19. The method of claim 17, wherein the fluid bearing is a hydrostatic bearing or a hydrodynamic bearing.

20. The method of claim 17, wherein the mechanical interface is a jaw, collet, chuck, magnetic chuck or clamping system.
